(19) United States
(12) Patent Application Publication
(10) Pub. No.: US 2025/0303977 A1
(43) Pub. Date: Oct. 2, 2025

(54) IN-VEHICLE EQUIPMENT HOLDING DEVICE

(71) Applicants: NIFCO INC., Yokosuka-shi (JP); ISUZU MOTORS LIMITED, Yokohama-shi (JP)

(72) Inventors: Yoichi HIRANO, Yokosuka-shi (JP); Tadamichi SAKAKI, Fujisawa-shi (JP)

(21) Appl. No.: 19/073,088

(22) Filed: Mar. 7, 2025

(30) Foreign Application Priority Data
Mar. 28, 2024 (JP) 2024-053345

(51) Int. Cl. B60R 13/02; B60R 11/00; B60R 11/04

(52) U.S. Cl. CPC B60R 13/02; B60R 11/04; B60R 2011/0026

(57) ABSTRACT

There is provided an in-vehicle equipment holding device that can prevent a cover from flying off even when an external force is applied to the cover and the cover comes off. The in-vehicle equipment holding device has an in-vehicle equipment bracket that is attached to a windshield of an automobile and to which in-vehicle equipment is attached, a cover attached to the in-vehicle equipment bracket, and a tether having a non-binding combiner joined to the in-vehicle equipment bracket and the cover. The tether has a connection portion having an elongated shape, a bracket-side engagement portion that is formed at one end portion of the connection portion and engages with a B-T engagement portion of the in-vehicle equipment bracket, and a cover-side engagement portion that is formed at the other end portion of the connection portion and engages with a C-T engagement portion of the cover.

### BACKGROUND OF THE INVENTION

### 1. Field of the Invention

The present invention relates to an in-vehicle equipment holding device that is used when a cover is attached to or detached from a bracket for setting in-vehicle equipment in a vehicle.

### 2. Description of the Related Art

Heretofore, in-vehicle equipment such as a camera is set in an automobile. Such in-vehicle equipment is mainly attached to the inner surface of a windshield. As a component for attaching the in-vehicle equipment to the windshield, for example, a device described in Japanese Unexamined Patent Application Publication No. 2016-203772 exists (hereinafter, referred to as “invention publicly-known in literature”). The invention publicly-known in literature has a bracket attached to a windshield and a cover that is attached to the bracket and covers in-vehicle equipment. The bracket and the cover are joined to each other through a clip attached to the inside of the cover.

[PLT 1] Japanese Unexamined Patent Application Publication No. 2016-203772

### SUMMARY OF THE INVENTION

However, if shock attributed to a collision of the automobile or shock to an instrument panel attributed to some kind of external force is applied to the device, the fastening by the clip may be released and the cover may drop off in some cases, and there may be a case in which the cover flicked off due to the shock hits a person who is in the vehicle.

The present invention is proposed in view of such a circumstance and an object thereof is to provide an in-vehicle equipment holding device that can prevent a cover from flying off even when an external force is applied to the cover and the cover comes off. Further, in a broad sense, an object of the present invention is to enhance the safety, which is a universal issue, by properly setting in-vehicle equipment for recognizing the outside of a vehicle and suppressing secondary damage attributed to a collision or the like.

In order to achieve the above-described object, an in-vehicle equipment holding device according to an aspect of the present invention includes an in-vehicle equipment bracket for setting in-vehicle equipment at a windshield of an automobile, a cover attached to the in-vehicle equipment bracket, and a tether having a non-binding combiner capable of combining the in-vehicle equipment bracket and the cover without being tied with the in-vehicle equipment bracket and the cover. The in-vehicle equipment bracket and the cover are anchored to each other by the tether in a state in which the in-vehicle equipment bracket and the cover are combined and in a state in which the in-vehicle equipment bracket and the cover are separated.

In the in-vehicle equipment holding device according to the aspect of the present invention, the tether may have a connection portion having an elongated shape and the non-binding combiner formed at both ends of the connection portion, and the non-binding combiner may have a bracket-side engagement portion that is formed at one end portion of the connection portion and engages with the in-vehicle equipment bracket and a cover-side engagement portion that is formed at the other end portion of the connection portion and engages with the cover.

In the in-vehicle equipment holding device according to the aspect of the present invention, the cover-side engagement portion may have an insertion path that extends to the inside of the cover-side engagement portion from the outside of the cover-side engagement portion, and an engagement release structure for releasing engagement between the cover-side engagement portion and the cover may be formed in the insertion path.

In the in-vehicle equipment holding device according to the aspect of the present invention, the cover may have an insertion hole into which the cover-side engagement portion is inserted, and a rear end on the opposite side to a direction of insertion into the insertion hole in the cover-side engagement portion may be aligned with an opening end portion of the insertion hole in a state in which the cover-side engagement portion is inserted in the insertion hole.

In the in-vehicle equipment holding device according to the aspect of the present invention, the non-binding combiner may be provided by forming the tether integrally with the in-vehicle equipment bracket or/and the cover.

In the in-vehicle equipment holding device according to the aspect of the present invention, in a case in which the non-binding combiner is provided by forming the tether integrally with the in-vehicle equipment bracket or the cover, the tether may have a non-integrated member engagement portion that engages with a non-integrated member that is the in-vehicle equipment bracket or the cover and that is not formed integrally with the tether.

In the in-vehicle equipment holding device according to the aspect of the present invention, the non-integrated member engagement portion may have an insertion path that extends to the inside of the non-integrated member engagement portion from the outside of the non-integrated member engagement portion, and an engagement release structure for releasing engagement between the non-integrated member engagement portion and the non-integrated member may be formed in the insertion path.

In the in-vehicle equipment holding device according to the aspect of the present invention, the non-integrated member may have an insertion hole into which the non-integrated member engagement portion is inserted, and a rear end on the opposite side to a direction of insertion into the insertion hole in the non-integrated member engagement portion may be aligned with an opening end portion of the insertion hole in a state in which the non-integrated member engagement portion is inserted in the insertion hole.

The in-vehicle equipment holding device according to the aspect of the present invention may be disposed at the windshield at a position near an instrument panel of the automobile.

In the in-vehicle equipment holding device according to the aspect of the present invention, in the state in which the in-vehicle equipment bracket and the cover are combined, the bracket-side engagement portion and the cover-side engagement portion may be close to each other on a forward side in a direction in which the cover is slid to be attached to the in-vehicle equipment bracket, and the connection portion may be folded back on a backward side that is the opposite side to the forward side.

The in-vehicle equipment holding device according to the aspect of the present invention includes the in-vehicle equipment bracket for setting the in-vehicle equipment at the windshield of the automobile, the cover attached to the in-vehicle equipment bracket, and the tether having the non-binding combiner capable of combining the in-vehicle equipment bracket and the cover without being tied with the in-vehicle equipment bracket and the cover. The in-vehicle equipment bracket and the cover are anchored to each other by the tether in the state in which the in-vehicle equipment bracket and the cover are combined and in the state in which the in-vehicle equipment bracket and the cover are separated. That is, the in-vehicle equipment bracket and the cover are connected to each other by the tether. Thus, the cover does not fly off even if some kind of external force is applied to the cover and the cover comes off.

In the in-vehicle equipment holding device according to the aspect of the present invention, the tether may have the connection portion having the elongated shape and the non-binding combiner formed at both ends of the connection portion, and the non-binding combiner may have the bracket-side engagement portion that is formed at the one end portion of the connection portion and engages with the in-vehicle equipment bracket and the cover-side engagement portion that is formed at the other end portion of the connection portion and engages with the cover. The bracket-side engagement portion engages with the in-vehicle equipment bracket, and the cover-side engagement portion engages with the cover. Further, both the engagement portions are connected to each other by the connection portion having the elongated shape. Thus, the cover does not fly off even if coming off.

In the in-vehicle equipment holding device according to the aspect of the present invention, the cover-side engagement portion may have the insertion path that extends to the inside of the cover-side engagement portion from the outside of the cover-side engagement portion, and the engagement release structure for releasing engagement between the cover-side engagement portion and the cover may be formed in the insertion path. When, for example, a tool or the like is inserted into the insertion path and the engagement release structure is operated, the engagement between the cover-side engagement portion and the cover is released. Thus, the tether can be detached from the cover.

In the in-vehicle equipment holding device according to the aspect of the present invention, the cover may have the insertion hole into which the cover-side engagement portion is inserted, and the rear end on the opposite side to the direction of insertion into the insertion hole in the cover-side engagement portion may be aligned with the opening end portion of the insertion hole in the state in which the cover-side engagement portion is inserted in the insertion hole. Because the rear end of the cover-side engagement portion is aligned with the opening end portion of the insertion hole when the cover-side engagement portion engages with the insertion hole of the cover, the worker can recognize the engagement of the cover-side engagement portion with the cover on the basis of the alignment of the rear end of the cover-side engagement portion with the opening end portion of the insertion hole. Thus, the engagement between the cover-side engagement portion and the cover can be visually checked objectively.

In the in-vehicle equipment holding device according to the aspect of the present invention, the non-binding combiner may be provided by forming the tether integrally with the in-vehicle equipment bracket or/and the cover. That is, the in-vehicle equipment bracket and the cover are connected to each other by the tether. Thus, the cover does not fly off even if some kind of external force is applied to the cover and the cover comes off. In particular, the non-binding combiner of the tether is formed integrally with the in-vehicle equipment bracket or the cover, or is formed integrally with the in-vehicle equipment bracket and the cover. Thus, robustness is achieved compared with the structure in which the tether is attached to and detached from the in-vehicle equipment bracket and the cover.

In the in-vehicle equipment holding device according to the aspect of the present invention, in the case in which the non-binding combiner is provided by forming the tether integrally with the in-vehicle equipment bracket or the cover, the non-binding combiner may have the non-integrated member engagement portion that engages with the non-integrated member that is the in-vehicle equipment bracket or the cover and that is not formed integrally with the tether. In the tether, the non-integrated member engagement portion as an end on one side engages with the non-integrated member, and the non-binding combiner as an end on the other side is formed integrally with the integrated member that is not the non-integrated member, of the in-vehicle equipment bracket and the cover. Thus, the cover does not fly off even if coming off. In particular, one side of the tether is formed integrally with the integrated member, and therefore robustness is achieved.

In the in-vehicle equipment holding device according to the aspect of the present invention, the non-integrated member engagement portion may have the insertion path that extends to the inside of the non-integrated member engagement portion from the outside of the non-integrated member engagement portion, and the engagement release structure for releasing engagement between the non-integrated member engagement portion and the non-integrated member may be formed in the insertion path. When, for example, a tool or the like is inserted into the insertion path and the engagement release structure is operated, the engagement between the non-integrated member engagement portion and the non-integrated member is released. Thus, the non-integrated member engagement portion can be detached from the non-integrated member.

In the in-vehicle equipment holding device according to the aspect of the present invention, the non-integrated member may have the insertion hole into which the non-integrated member engagement portion is inserted, and the rear end on the opposite side to the direction of insertion into the insertion hole in the non-integrated member engagement portion may be aligned with the opening end portion of the insertion hole in the state in which the non-integrated member engagement portion is inserted in the insertion hole. Because the rear end of the non-integrated member engagement portion is aligned with the opening end portion of the insertion hole when the non-integrated member engagement portion engages with the insertion hole of the non-integrated member, the worker can recognize the engagement of the non-integrated member engagement portion with the non-integrated member on the basis of the alignment of the rear end of the non-integrated member engagement portion with the opening end portion of the insertion hole. Thus, the engagement between the non-integrated member engagement portion and the non-integrated member can be visually checked objectively.

The in-vehicle equipment holding device according to the aspect of the present invention may be disposed at the windshield at a position near the instrument panel of the automobile. In a truck or the like in which the positions of a cockpit and a windshield are high, the in-vehicle equipment holding device is set at a proper position.

In the in-vehicle equipment holding device according to the aspect of the present invention, in the state in which the in-vehicle equipment bracket and the cover are combined, the bracket-side engagement portion and the cover-side engagement portion may be close to each other on the forward side in the direction in which the cover is slid to be attached to the in-vehicle equipment bracket, and the connection portion may be folded back on the backward side that is the opposite side to the forward side. Both end portions (bracket-side engagement portion and cover-side engagement portion) of the tether are disposed on the forward side, and the folded-back portion of the tether is disposed on the backward side. Thus, the tether has such a length as to extend from the forward side to the backward side and further extend back to the forward side. Therefore, in work of attaching the cover to the in-vehicle equipment bracket, a sufficient length of the tether at such a degree as not to interfere with the work is ensured even when both the members are connected to each other by the tether. In addition, the tether is arranged inside both the members even when being long.

### BRIEF DESCRIPTION OF THE DRAWINGS

FIG. 1 is an exploded perspective view of an in-vehicle equipment holding device according to an embodiment of the present invention.

FIG. 2 is a front view of an in-vehicle equipment bracket of the in-vehicle equipment holding device according to the embodiment of the present invention.

FIG. 3 is a back view of a cover of the in-vehicle equipment holding device according to the embodiment of the present invention.

FIG. 4 depicts a section along line IV-IV in FIG. 3 and is a partial sectional view of the cover of the in-vehicle equipment holding device according to the embodiment of the present invention.

FIG. 5 is a perspective view of a tether of the in-vehicle equipment holding device according to the embodiment of the present invention.

FIG. 6 is a top view of the tether of the in-vehicle equipment holding device according to the embodiment of the present invention.

FIG. 7 is a side view of the tether of the in-vehicle equipment holding device according to the embodiment of the present invention.

FIG. 8 is an enlarged front view of the tether of the in-vehicle equipment holding device according to the embodiment of the present invention.

FIG. 9 depicts a section along line IX-IX in FIG. 6 and is an enlarged side sectional view of the tether of the in-vehicle equipment holding device according to the embodiment of the present invention.

FIG. 10 depicts a section along line X-X in FIG. 7 and is an enlarged front sectional view of the tether of the in-vehicle equipment holding device according to the embodiment of the present invention.

FIG. 11 is an explanatory diagram of a first process depicting an assembly process of the in-vehicle equipment holding device according to the embodiment of the present invention.

FIG. 12 is an explanatory diagram of a second process depicting the assembly process of the in-vehicle equipment holding device according to the embodiment of the present invention.

FIG. 13 is an explanatory diagram of a third process depicting the assembly process of the in-vehicle equipment holding device according to the embodiment of the present invention.

FIG. 14 is an explanatory diagram of a fourth process depicting the assembly process of the in-vehicle equipment holding device according to the embodiment of the present invention.

FIG. 15 depicts a section along line XV-XV in FIG. 14 and is an explanatory sectional view of the fourth process depicting a section in the fourth process regarding the in-vehicle equipment holding device according to the embodiment of the present invention.

FIG. 16 is an explanatory sectional view of a disassembly process depicting a section in the disassembly process regarding the in-vehicle equipment holding device according to the embodiment of the present invention in FIG. 15.

FIG. 17 is an explanatory diagram of a fifth process depicting the assembly process of the in-vehicle equipment holding device according to the embodiment of the present invention.

FIG. 18 depicts a section along line XVIII-XVIII in FIG. 17 and is an explanatory sectional view of the fifth process depicting a section in the fifth process regarding the in-vehicle equipment holding device according to the embodiment of the present invention.

FIG. 19 is an explanatory diagram of a sixth process depicting the assembly process of the in-vehicle equipment holding device according to the embodiment of the present invention.

FIG. 20 depicts a section along line XX-XX in FIG. 19 and is an explanatory sectional view of the sixth process depicting a section in the sixth process regarding the in-vehicle equipment holding device according to the embodiment of the present invention.

### DESCRIPTION OF THE PREFERRED EMBODIMENT

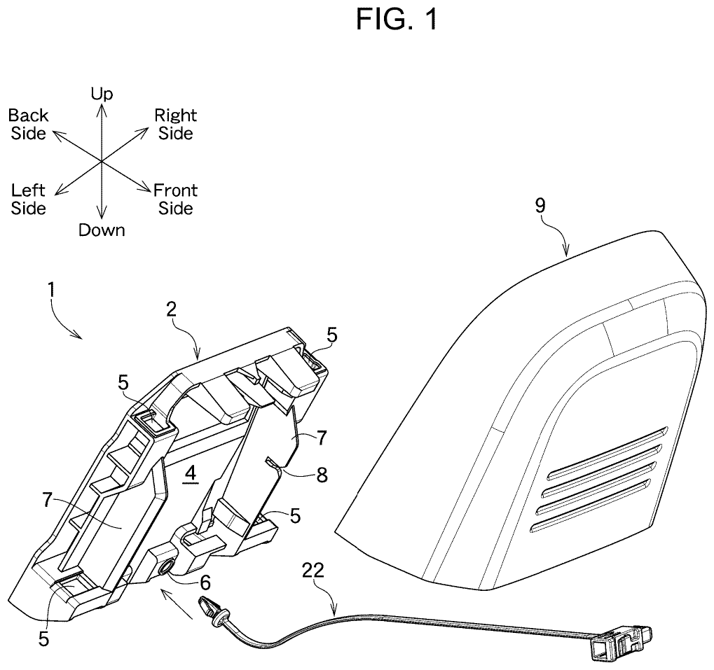

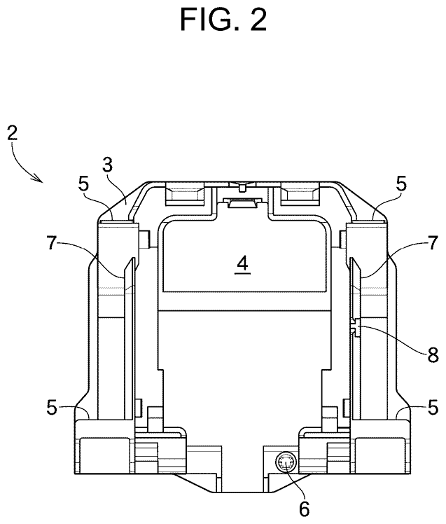

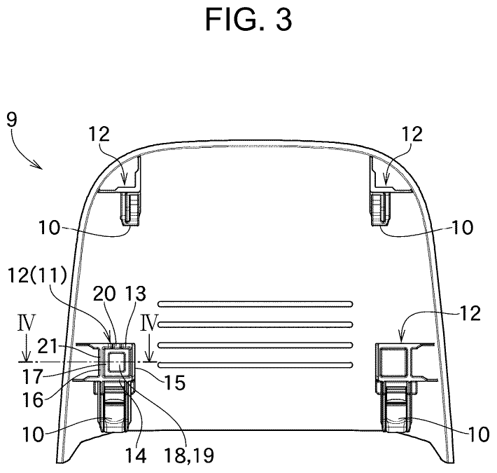

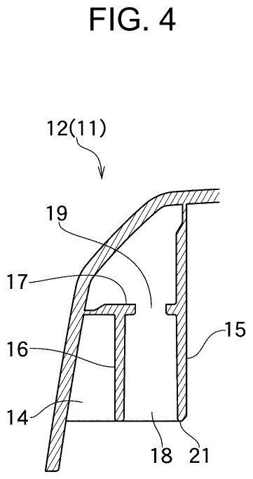

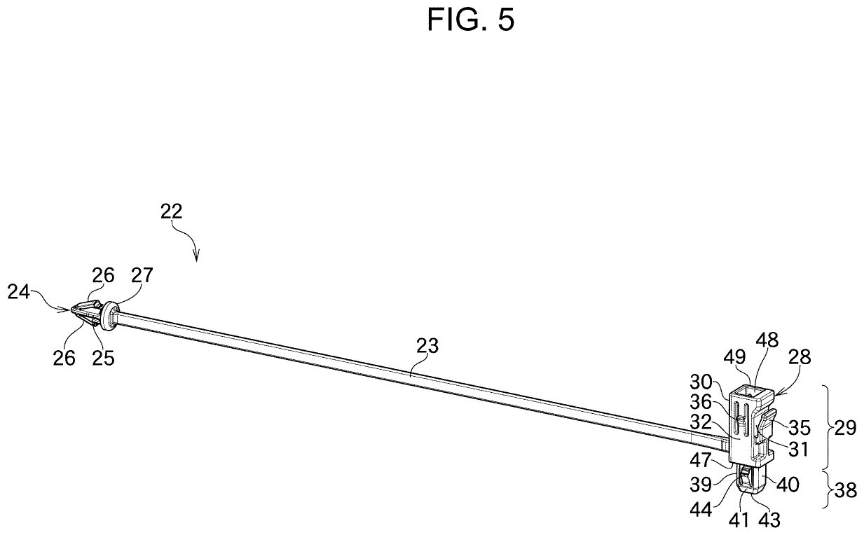

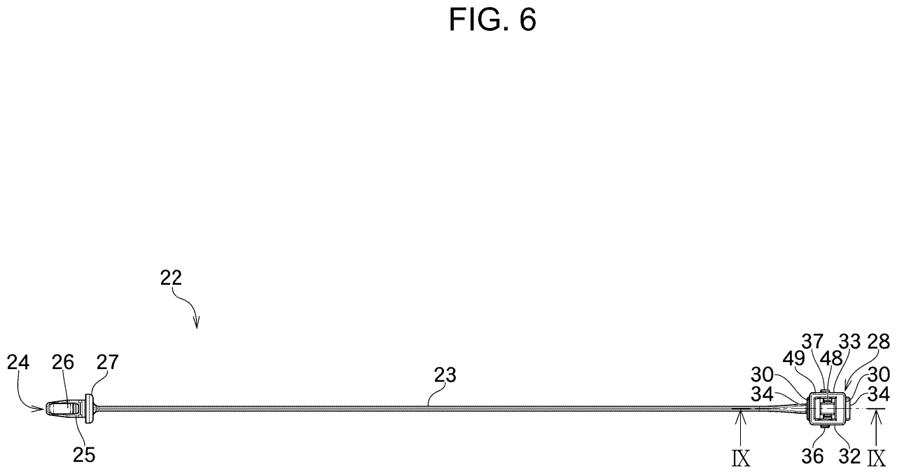

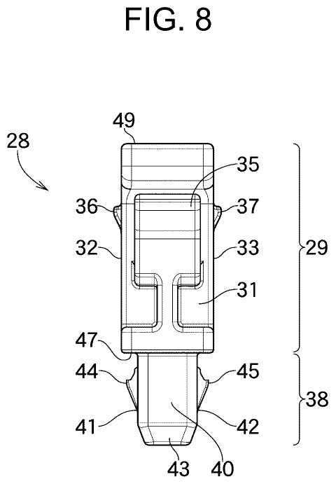

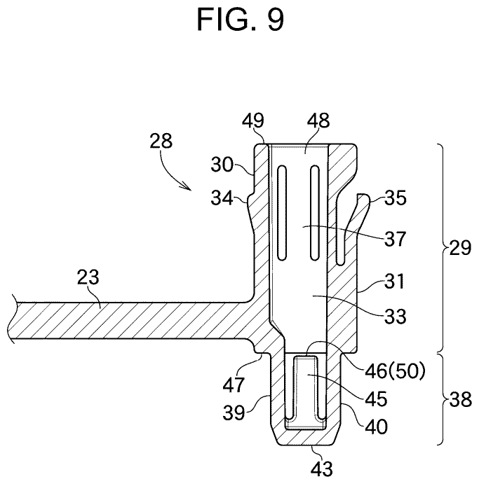

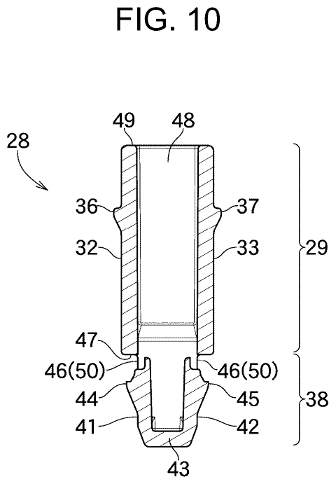

An in-vehicle equipment holding device according to an embodiment of the present invention is described below with reference to the drawings. FIG. 1 depicts an exploded view of an in-vehicle equipment holding device 1 according to the present embodiment. FIG. 2 depicts an in-vehicle equipment bracket 2 forming the in-vehicle equipment holding device 1. FIGS. 3 and 4 depict a cover 9 forming the in-vehicle equipment holding device 1. FIGS. 5 to 10 depict a tether 22 forming the in-vehicle equipment holding device 1.

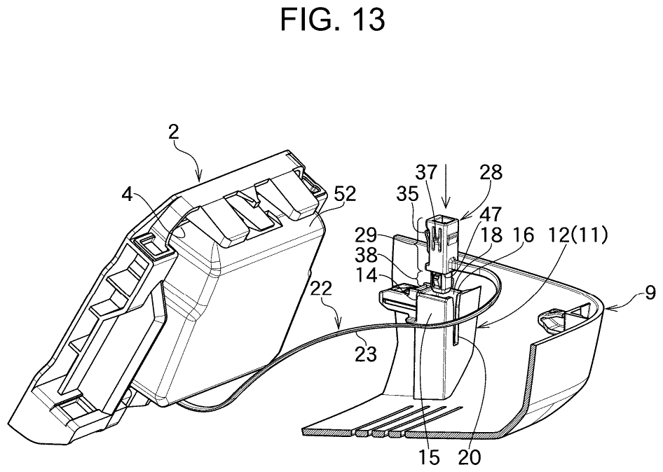

Referring to FIG. 1, the in-vehicle equipment holding device 1 is used when in-vehicle equipment 52 (see FIG. 13) is set in a vehicle. The in-vehicle equipment 52 is, for example, an image pickup unit such as a camera or a video camera, an environment detector such as a rain sensor, or the like. The in-vehicle equipment holding device 1 has the in-vehicle equipment bracket 2 that is attached to a windshield (not shown in the drawings) of an automobile and to which the in-vehicle equipment 52 is attached, the cover 9 attached to the in-vehicle equipment bracket 2, and the tether 22 joined to the in-vehicle equipment bracket 2 and the cover 9. The in-vehicle equipment bracket 2 and the cover 9 are anchored to each other by being joined to each other by the tether 22. The in-vehicle equipment bracket 2 and the cover 9 are combined in a state in which they are anchored to each other by the tether 22, and remain anchored to each other by the tether 22 even when being separated through application of some kind of external force thereto. In the following description, the side at which the in-vehicle equipment holding device 1 is attached to the windshield is defined as the back side (Back Side), and the side oriented toward a person who is in the automobile is defined as the front side (Front Side). Further, both sides in the entire length direction of the in-vehicle equipment holding device 1 are defined as the upper side and the lower side (Up and Down), and both sides in the width direction of the in-vehicle equipment holding device 1 are defined as the left side and the right side (Left Side and Right Side) (see FIG. 1).

As depicted in FIGS. 1 and 2, the in-vehicle equipment bracket 2 is a component obtained by forming various engagement structures in a plate-shaped base portion 3. The engagement structures have an in-vehicle equipment engagement portion 4 to which the in-vehicle equipment 52 is attached to engage therewith, cover engagement portions 5 with which the cover 9 engages, and a bracket-tether engagement portion with which the tether 22 engages (hereinafter, the bracket-tether engagement portion is referred to as the “B-T engagement portion 6”). The in-vehicle equipment engagement portion 4 is a portion at the center of the base portion 3 and occupies most of the area of the base portion 3. A pair of left and right dividing wall portions 7 is formed on the left and the right of the in-vehicle equipment engagement portion 4. The dividing wall portions 7 are plate-shaped pieces projecting from the base portion 3 toward the front side. A groove 8 is formed in the dividing wall portion 7. The cover engagement portions 5 are holes at four corners of the base portion 3 and are opened toward the lower side. The B-T engagement portion 6 is a hole that is closer to the right side or the left side relative to the center in the vicinity of the lower end of the base portion 3 and is opened toward the back side.

As depicted in FIGS. 1 and 3, the cover 9 has a dome shape and covers the front side of the in-vehicle equipment bracket 2. Bracket engagement portions 10 that engage with the in-vehicle equipment bracket 2 and a cover-tether engagement portion with which the tether 22 engages (hereinafter, the cover-tether engagement portion is referred to as the “C-T engagement portion 11”) are formed inside the cover 9. The bracket engagement portions 10 are protrusions that project toward the lower side from base portions 12 formed at four corners of the cover 9. The C-T engagement portion 11 is formed at the base portion 12 at a lower corner. The base portion 12 has a first base surface portion 13 that is an upper surface, a second base surface portion 14 that is a lower surface facing the first base surface portion 13 with a space therebetween, and a third base surface portion 15 that is a side surface connected to ends of the first base surface portion 13 and the second base surface portion 14. The base portion 12 has also a fourth base surface portion 16 that is a side surface that faces the third base surface portion 15 with a space therebetween and is connected to the first base surface portion 13 and the second base surface portion 14, and a bottom surface portion 17 connected to the first base surface portion 13 to the fourth base surface portion 16. An insertion hole 18 is formed inside a hollow rectangular parallelepiped formed of the respective base surface portions 13 to 16. As depicted in FIG. 4, the insertion hole 18 is a hole opened toward the front side and is delimited by the bottom surface portion 17. A bottom surface aperture 19 is formed as a hole in the bottom surface portion 17, and the insertion hole 18 is continuous with the bottom surface aperture 19. As depicted in FIG. 3, a notch 20 is formed in the first base surface portion 13. The notch 20 is a groove linearly formed from an opening end portion 21 of the insertion hole 18 toward the front side. On the basis of the above configuration, the C-T engagement portion 11 is formed by the first base surface portion 13, the second base surface portion 14, the third base surface portion 15, the fourth base surface portion 16, the bottom surface portion 17, the insertion hole 18, the bottom surface aperture 19, the notch 20, and the opening end portion 21.

As depicted in FIGS. 5 to 10, the tether 22 has a connection portion 23 having an elongated shape, and a bracket-side engagement portion 24 and a cover-side engagement portion 28 as non-binding combiners formed at both ends of the connection portion 23. The non-binding combiners can combine the in-vehicle equipment bracket 2 and the cover 9 without being tied with them. In other words, each non-binding combiner is not a knot or the like formed by manual tying of a string or the like made of fiber or vinyl. The bracket-side engagement portion 24 is formed at one end portion of the connection portion 23, and engages with the B-T engagement portion 6 of the in-vehicle equipment bracket 2. The cover-side engagement portion 28 is formed at the other end portion of the connection portion 23, and engages with the C-T engagement portion 11 of the cover 9. The connection portion 23 has a thin, long string shape with a predetermined length. The definition of the predetermined length is as follows. The predetermined length is a length that causes no problem in work of combining the in-vehicle equipment bracket 2 and the cover 9 even in a state in which the in-vehicle equipment bracket 2 and the cover 9 are anchored to each other by joining of the tether 22 to the in-vehicle equipment bracket 2 and the cover 9. In addition, the predetermined length is a length that keeps the cover 9 from reaching a person who is in the vehicle when the cover 9 has come off the in-vehicle equipment bracket 2. If the connection portion 23 is too short, the in-vehicle equipment bracket 2 and the cover 9 are restrained at a short distance and thus the work of combining the in-vehicle equipment bracket 2 and the cover 9 becomes difficult. On the other hand, if the connection portion 23 is too long, there is a possibility that the cover 9 that has come off the in-vehicle equipment bracket 2 hits a person who is in the vehicle.

The bracket-side engagement portion 24 has a shaft portion 25 extending from the one end portion of the connection portion 23, a pair of tip anchor pieces 26 extending from the tip of the shaft portion 25 toward the opposite side, and a flange portion 27 formed on the base side of the shaft portion 25. Because being elastically deformed, the tip anchor pieces 26 come closer to the shaft portion 25 when an external force is applied thereto, and return to the original posture when being released from the external force.

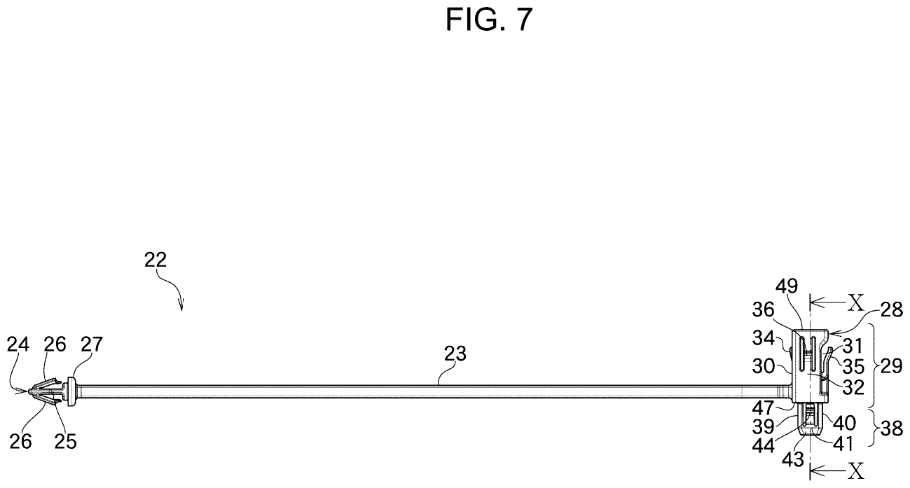

The cover-side engagement portion 28 has a base-side box portion 29 having a hollow rectangular parallelepiped shape and a protruding box portion 38 that projects from an end portion of the base-side box portion 29 in the longitudinal direction and has a hollow rectangular parallelepiped shape. The protruding box portion 38 is smaller than the base-side box portion 29. Thus, the base-side box portion 29 and the protruding box portion 38 are connected to each other into a stepped form, and a step portion 47 is formed at the boundary between the outer surface of the base-side box portion 29 and the outer surface of the protruding box portion 38. The inner surface of the base-side box portion 29 is connected to the inner surface of the protruding box portion 38, and an insertion path 48 is formed inside the base-side box portion 29 and the protruding box portion 38. The insertion path 48 is opened at a box end portion 49 (upper end side in FIGS. 7 to 10) that is an end portion on the opposite side to the protruding box portion 38 in the base-side box portion 29, and is closed on the opposite side to the base-side box portion 29 (lower end side in FIGS. 7 to 10) in the protruding box portion 38. This allows the insertion path 48 to extend to the inside of the cover-side engagement portion 28 from the outside.

The base-side box portion 29 has a first base-side box surface portion 30 to which the connection portion 23 is connected, a second base-side box surface portion 31 facing the first base-side box surface portion 30 with a space therebetween, and a third base-side box surface portion 32 and a fourth base-side box surface portion 33 that are connected to ends of the first base-side box surface portion 30 and the second base-side box surface portion 31 and face each other with a space therebetween. A first base-side bump 34 is formed in the outer surface of the first base-side box surface portion 30. A second base-side box anchor piece 35 is formed in the outer surface of the second base-side box surface portion 31. A third base-side box anchor piece 36 is formed at part of the third base-side box surface portion 32. A fourth base-side box anchor piece 37 is formed at part of the fourth base-side box surface portion 33.

The protruding box portion 38 has a first protruding box surface portion 39, a second protruding box surface portion 40 facing the first protruding box surface portion 39 with a space therebetween, and a third protruding box surface portion 41 and a fourth protruding box surface portion 42 that are connected to ends of the first protruding box surface portion 39 and the second protruding box surface portion 40 and face each other with a space therebetween. The protruding box portion 38 has a protruding box bottom surface portion 43 connected to end portions of the respective protruding box surface portions 39 to 42 in the longitudinal direction. A third protruding box anchor piece 44 is formed at part of the third protruding box surface portion 41. A fourth protruding box anchor piece 45 is formed at part of the fourth protruding box surface portion 42. The third protruding box anchor piece 44 and the fourth protruding box anchor piece 45 are connected to the protruding box bottom surface portion 43. However, the periphery of them is separated from the third protruding box surface portion 41 and the fourth protruding box surface portion 42. Therefore, a tip portion of the third protruding box anchor piece 44 and a tip portion of the fourth protruding box anchor piece 45 extend to a position in front of the step portion 47 and are not connected to the step portion 47. Thus, a gap 46 is formed between the tip portion of the third protruding box anchor piece 44 and the step portion 47, and between the tip portion of the fourth protruding box anchor piece 45 and the step portion 47.

Because being elastically deformed, the second base-side box anchor piece 35, the third base-side box anchor piece 36, the fourth base-side box anchor piece 37, the third protruding box anchor piece 44, and the fourth protruding box anchor piece 45 come slightly closer to the inside of the cover-side engagement portion 28 when an external force is applied thereto, and return to the original posture when being released from the external force.

In the insertion path 48 of the cover-side engagement portion 28, engagement release structures 50 for releasing engagement between the cover-side engagement portion 28 and the cover 9 are formed. The engagement release structures 50 are implemented by the gaps 46 formed between the step portion 47 and the third protruding box anchor piece 44 of the protruding box portion 38 and between the step portion 47 and the fourth protruding box anchor piece 45 of the protruding box portion 38 (operation and effects of the engagement release structure 50 are described later).

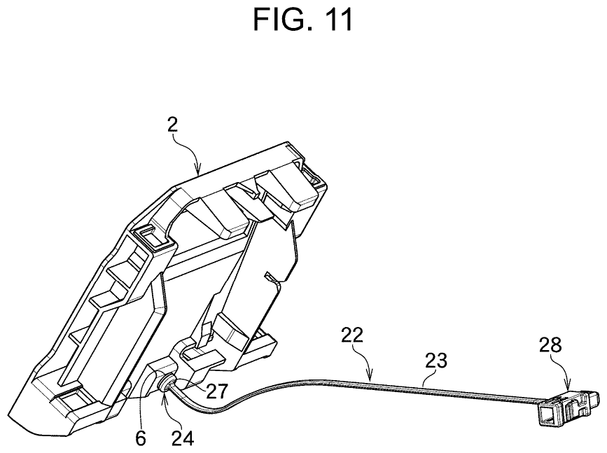

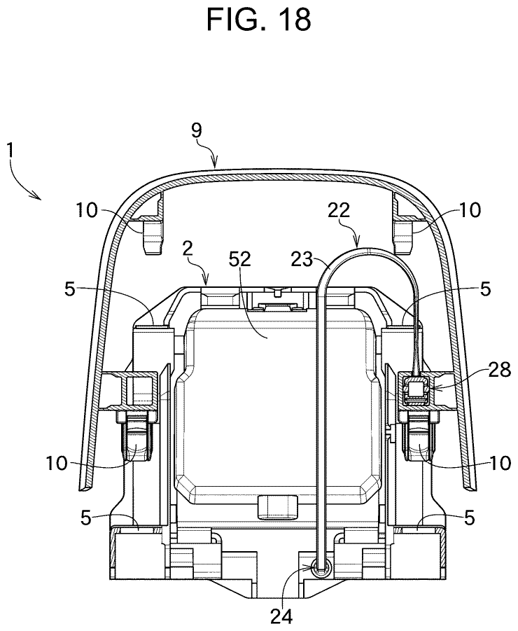

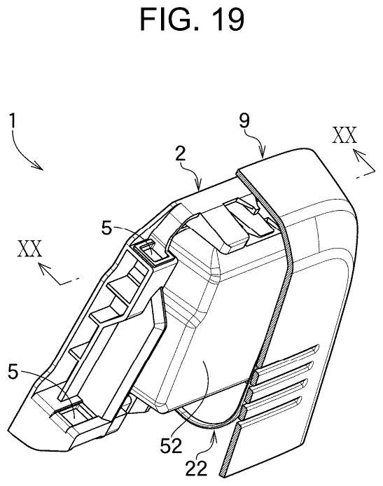

The in-vehicle equipment holding device 1 is configured as described above. Next, with reference to the drawings, an assembly procedure of the in-vehicle equipment holding device 1 is described together with operation and effects of the in-vehicle equipment holding device 1. FIGS. 11 to 20 depict, as an assembly process of the in-vehicle equipment holding device 1, a procedure of combining the in-vehicle equipment bracket 2 and the cover 9 while joining the in-vehicle equipment bracket 2 and the cover 9 to each other by the tether 22.

As depicted in FIG. 11, the bracket-side engagement portion 24 of the tether 22 is inserted into the B-T engagement portion 6 of the in-vehicle equipment bracket 2. When being inserted into the B-T engagement portion 6 as a hole, the tip anchor pieces 26 of the bracket-side engagement portion 24 are pushed to be elastically deformed by the edge of the hole while advancing in the hole. After passing through the hole, the tip anchor pieces 26 return to the original posture. The flange portion 27 abuts against the edge of the hole, and thereby the bracket-side engagement portion 24 is positioned. Thus, the bracket-side engagement portion 24 engages with the B-T engagement portion 6.

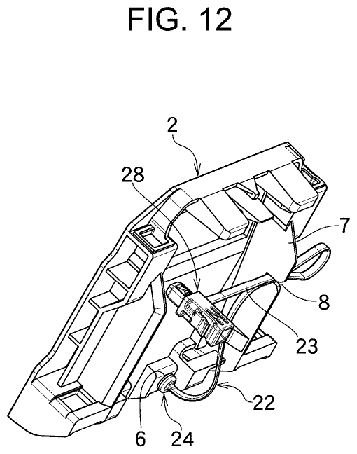

In order to prevent the elongated tether 22 from interfering with work of applying the in-vehicle equipment bracket 2 to a windshield of an automobile, as depicted in FIG. 12, the connection portion 23 of the tether 22 is attached, in a bent state, to the groove 8 of the in-vehicle equipment bracket 2. In this state, the in-vehicle equipment bracket 2 is disposed and attached to the windshield of the automobile, for example, at a position near an instrument panel (the in-vehicle equipment bracket 2 may be disposed near a rear-view mirror of an automobile in some cases). After the in-vehicle equipment bracket 2 is attached to the windshield, the connection portion 23 is detached from the groove 8.

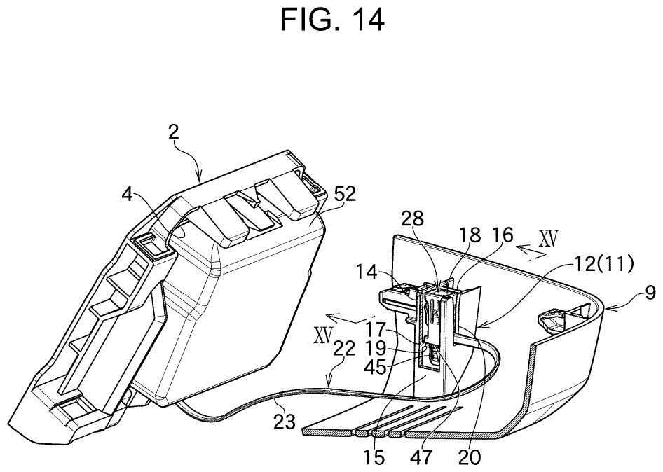

As depicted in FIGS. 13 and 14, the in-vehicle equipment 52 is attached to the in-vehicle equipment engagement portion 4 of the in-vehicle equipment bracket 2. The cover-side engagement portion 28 of the tether 22 is inserted into the base portion 12 of the C-T engagement portion 11 of the cover 9. When the base-side box portion 29 of the cover-side engagement portion 28 is inserted into the insertion hole 18 of the base portion 12, the connection portion 23 of the tether 22 is made to pass through the notch 20 of the base portion 12. The second base-side box anchor piece 35, the third base-side box anchor piece 36, and the fourth base-side box anchor piece 37 of the base-side box portion 29 are pushed to be elastically deformed by the second base surface portion 14, the third base surface portion 15, and the fourth base surface portion 16 of the base portion 12 while advancing in the insertion hole 18. When the protruding box portion 38 of the cover-side engagement portion 28 is inserted into the bottom surface aperture 19 of the base portion 12, the third protruding box anchor piece 44 and the fourth protruding box anchor piece 45 of the protruding box portion 38 are pushed to be elastically deformed by the edge of the bottom surface aperture 19 while advancing in the bottom surface aperture 19. After passing through the bottom surface aperture 19, these pieces 44 and 45 return to the original posture. Simultaneously, the step portion 47 of the cover-side engagement portion 28 abuts against the bottom surface portion 17 of the base portion 12, and the cover-side engagement portion 28 is positioned. Thus, the cover-side engagement portion 28 engages with the C-T engagement portion 11. Due to the elastic deformation of the second base-side box anchor piece 35, the third base-side box anchor piece 36, and the fourth base-side box anchor piece 37, the cover-side engagement portion 28 is clamped by the inner surface of the C-T engagement portion 11. This can prevent the cover-side engagement portion 28 from dropping off or making an odd sound due to a backlash of the cover-side engagement portion 28.

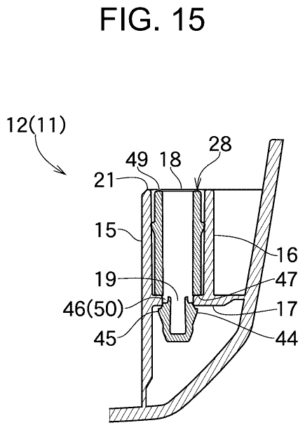

As depicted in FIG. 15, in a state in which the cover-side engagement portion 28 engages with the C-T engagement portion 11, the box end portion 49 as the end portion in the cover-side engagement portion 28 on the opposite side to the direction of the insertion into the insertion hole 18 of the base portion 12 is aligned with the opening end portion 21 of the insertion hole 18. The worker can recognize the engagement of the cover-side engagement portion 28 with the C-T engagement portion 11 on the basis of the alignment of the box end portion 49 of the cover-side engagement portion 28 with the opening end portion 21 of the insertion hole 18. Thus, the engagement between the cover-side engagement portion 28 and the C-T engagement portion 11 can be visually checked objectively.

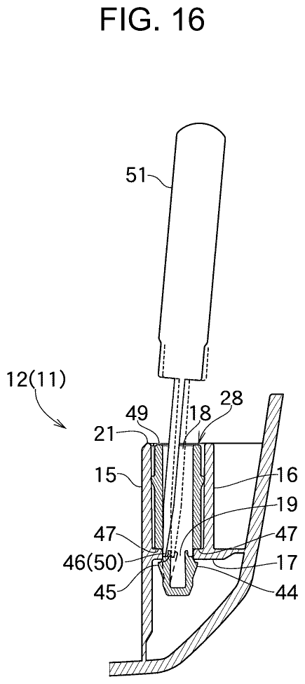

As depicted in FIG. 16, the engagement between the cover-side engagement portion 28 and the cover 9 is released by operation of the engagement release structure 50. For example, when a tool 51 is inserted into the insertion path 48 of the cover-side engagement portion 28 and is made to pass through the bottom surface aperture 19, the tool 51 enters the gap 46 between the third protruding box anchor piece 44 or the fourth protruding box anchor piece 45 and the step portion 47. This elastically deforms the third protruding box anchor piece 44 or the fourth protruding box anchor piece 45 inward. In this state, the cover-side engagement portion 28 is pulled out. This releases the engagement between the cover-side engagement portion 28 and the C-T engagement portion 11. Thus, the tether 22 can be detached from the cover 9.

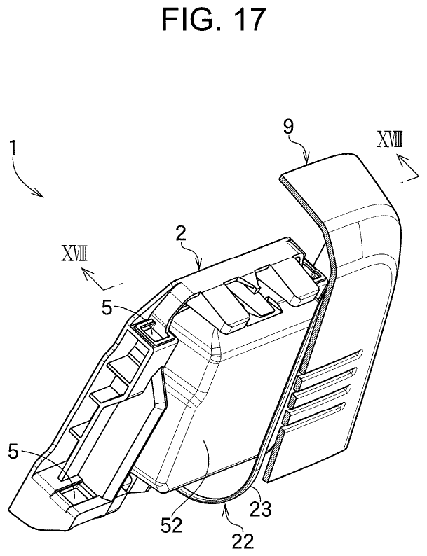

As depicted in FIGS. 17 to 20, the cover 9 is attached to the in-vehicle equipment bracket 2 in a state in which the in-vehicle equipment bracket 2 and the cover 9 are joined and anchored to each other by the tether 22. The bracket engagement portions 10 of the cover 9 are inserted into the cover engagement portions 5 of the in-vehicle equipment bracket 2, and thereby the cover 9 engages with the in-vehicle equipment bracket 2.

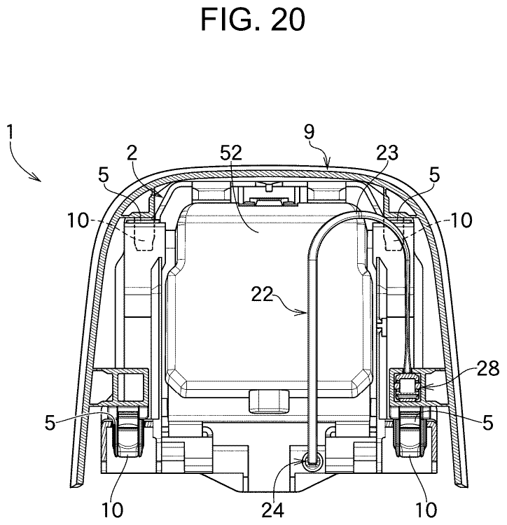

As depicted in FIG. 20, in a state in which the in-vehicle equipment bracket 2 and the cover 9 are combined, the bracket-side engagement portion 24 and the cover-side engagement portion 28 are close to each other on the forward side (in FIG. 20, the lower side) in the direction in which the cover 9 is slid to be attached to the in-vehicle equipment bracket 2 (in FIG. 20, the downward direction, and hereinafter the direction in which the cover 9 is slid relative to the in-vehicle equipment bracket 2 is referred to as the “slide direction”), and the connection portion 23 is folded back on the backward side (in FIG. 20, the upper side) that is the opposite side to the forward side in the slide direction. Both the end portions (bracket-side engagement portion 24 and cover-side engagement portion 28) of the tether 22 are disposed on the forward side, and the folded-back portion of the tether 22 is disposed on the backward side. Thus, the connection portion 23 has such a length as to extend from the forward side to the backward side and further extend back to the forward side. Therefore, in work of attaching the cover 9 to the in-vehicle equipment bracket 2, a sufficient length of the tether 22 at such a degree as not to interfere with the work is ensured although the in-vehicle equipment bracket 2 and the cover 9 are connected to each other by the tether 22. In addition, the tether 22 is arranged inside the in-vehicle equipment holding device 1 even when being long.

As described above, in the in-vehicle equipment holding device 1, the in-vehicle equipment bracket 2 and the cover 9 are connected to each other by the tether 22. Thus, the cover 9 does not fly off even if some kind of external force is applied to the cover 9 and the cover 9 comes off. In particular, the bracket-side engagement portion 24 of the tether 22 engages with the in-vehicle equipment bracket 2, and the cover-side engagement portion 28 of the tether 22 engages with the cover 9. Further, both the engagement portions 24 and 28 are connected to each other by the connection portion 23 having the elongated shape. Thus, the cover 9 does not fly off even if coming off the in-vehicle equipment bracket 2.

Next, other embodiments (not shown in the drawings) of the present invention are described. The following description is mainly description of configurations different from the in-vehicle equipment holding device 1 according to the first embodiment, and description of configurations similar to those of the in-vehicle equipment holding device 1 is omitted as appropriate.

An in-vehicle equipment holding device according to a second embodiment is different from the in-vehicle equipment holding device 1 in that the non-binding combiner of the tether is formed integrally with the in-vehicle equipment bracket. Therefore, in the in-vehicle equipment holding device according to the second embodiment, the in-vehicle equipment bracket does not have the B-T engagement portion, and the tether does not have the bracket-side engagement portion. On the other hand, the cover as the non-integrated member that is not formed integrally with the tether has the C-T engagement portion, and the tether has the cover-side engagement portion as the non-integrated member engagement portion. Thus, the cover does not fly off even if coming off the in-vehicle equipment bracket. In particular, the non-binding combiner of the tether is formed integrally with the in-vehicle equipment bracket, and therefore robustness is achieved.

Similarly to the in-vehicle equipment holding device 1, in the in-vehicle equipment holding device according to the second embodiment, the cover-side engagement portion has the engagement release structure, and thus engagement between the cover-side engagement portion and the cover is released by operation of the engagement release structure. Thus, the tether can be detached from the cover.

Further, similarly to the in-vehicle equipment holding device 1, in the in-vehicle equipment holding device according to the second embodiment, the box end portion of the cover-side engagement portion is aligned with the opening end portion of the insertion hole of the C-T engagement portion in a state in which the cover-side engagement portion engages with the C-T engagement portion. The worker can recognize the engagement of the cover-side engagement portion with the C-T engagement portion on the basis of the alignment of the box end portion with the opening end portion, and thus objectively visually check the engagement between the cover-side engagement portion and the C-T engagement portion.

An in-vehicle equipment holding device according to a third embodiment is different from the in-vehicle equipment holding device 1 in that the non-binding combiner of the tether is formed integrally with the cover. Therefore, in the in-vehicle equipment holding device according to the third embodiment, the cover does not have the C-T engagement portion, and the tether does not have the cover-side engagement portion. On the other hand, the in-vehicle equipment bracket as the non-integrated member that is not formed integrally with the tether has the B-T engagement portion, and the tether has the bracket-side engagement portion as the non-integrated member engagement portion. Thus, the cover does not fly off even if coming off the in-vehicle equipment bracket. In particular, the non-binding combiner of the tether is formed integrally with the cover, and therefore robustness is achieved.

An in-vehicle equipment holding device according to a fourth embodiment is different from the in-vehicle equipment holding device 1 in that the non-binding combiner of the tether is formed integrally with the cover and in that the B-T engagement portion has the engagement release structure. Therefore, in the in-vehicle equipment holding device according to the fourth embodiment, the cover does not have the C-T engagement portion, and the tether does not have the cover-side engagement portion. On the other hand, the in-vehicle equipment bracket as the non-integrated member that is not formed integrally with the tether has the B-T engagement portion, and the tether has the bracket-side engagement portion as the non-integrated member engagement portion. Moreover, in the in-vehicle equipment holding device according to the fourth embodiment, the structure of the B-T engagement portion is the same as the C-T engagement portion 11 in the in-vehicle equipment holding device 1, and the structure of the bracket-side engagement portion is the same as the cover-side engagement portion 28 in the in-vehicle equipment holding device 1.

Thus, the cover does not fly off even if coming off the in-vehicle equipment bracket. In particular, the non-binding combiner of the tether is formed integrally with the cover, and therefore robustness is achieved. Further, similarly to the in-vehicle equipment holding device 1, in the in-vehicle equipment holding device according to the fourth embodiment, the bracket-side engagement portion has the engagement release structure, and thus engagement between the bracket-side engagement portion and the in-vehicle equipment bracket is released by operation of the engagement release structure. Thus, the tether can be detached from the in-vehicle equipment bracket.

Moreover, similarly to the in-vehicle equipment holding device 1, in the in-vehicle equipment holding device according to the fourth embodiment, the box end portion of the bracket-side engagement portion is aligned with the opening end portion of the insertion hole of the B-T engagement portion in a state in which the bracket-side engagement portion engages with the B-T engagement portion. The worker can recognize the engagement of the bracket-side engagement portion with the B-T engagement portion on the basis of the alignment of the box end portion with the opening end portion, and thus objectively visually check the engagement between the bracket-side engagement portion and the B-T engagement portion.

An in-vehicle equipment holding device according to a fifth embodiment is different from the in-vehicle equipment holding device 1 in that the non-binding combiners of the tether are formed integrally with the in-vehicle equipment bracket and the cover. Therefore, in the in-vehicle equipment holding device according to the fifth embodiment, the cover does not have the C-T engagement portion, and the in-vehicle equipment bracket does not have the B-T engagement portion. In addition, the tether does not have the cover-side engagement portion and does not have the bracket-side engagement portion. Thus, the cover does not fly off even if coming off the in-vehicle equipment bracket. In particular, the non-binding combiners of the tether are formed integrally with the cover and the in-vehicle equipment bracket, and therefore robustness is achieved.

In the other embodiments of the present invention, the bracket-side engagement portion and/or the cover-side engagement portion as the non-binding combiner of the tether may have any configuration as long as having such a form as to be joined to the in-vehicle equipment bracket and/or the cover. Therefore, the non-binding combiner includes, for example, a mechanical joint structure different from the above-described embodiments and one based on a magnet.

Although the embodiments of the present invention have been described in detail above, the present invention is not limited to the above-described embodiments. Further, various design changes can be carried out for the present invention without departing from the scope of the invention.

What is claimed is:

1. An in-vehicle equipment holding device comprising:
an in-vehicle equipment bracket for setting in-vehicle equipment at a windshield of an automobile;
a cover attached to the in-vehicle equipment bracket; and
a tether having a non-binding combiner capable of combining the in-vehicle equipment bracket and the cover without being tied with the in-vehicle equipment bracket and the cover, wherein
the in-vehicle equipment bracket and the cover are anchored to each other by the tether in a state in which the in-vehicle equipment bracket and the cover are combined and in a state in which the in-vehicle equipment bracket and the cover are separated.

2. The in-vehicle equipment holding device according to claim 1, wherein
the tether has
a connection portion having an elongated shape, and
the non-binding combiner formed at both ends of the connection portion, and
the non-binding combiner has
a bracket-side engagement portion that is formed at one end portion of the connection portion and engages with the in-vehicle equipment bracket, and
a cover-side engagement portion that is formed at the other end portion of the connection portion and engages with the cover.

3. The in-vehicle equipment holding device according to claim 2, wherein
the cover-side engagement portion has an insertion path that extends to inside of the cover-side engagement portion from outside of the cover-side engagement portion, and an engagement release structure for releasing engagement between the cover-side engagement portion and the cover is formed in the insertion path.

4. The in-vehicle equipment holding device according to claim 2, wherein
the cover has an insertion hole into which the cover-side engagement portion is inserted, and
a rear end on an opposite side to a direction of insertion into the insertion hole in the cover-side engagement portion is aligned with an opening end portion of the insertion hole in a state in which the cover-side engagement portion is inserted in the insertion hole.

5. The in-vehicle equipment holding device according to claim 3, wherein
the cover has an insertion hole into which the cover-side engagement portion is inserted, and
a rear end on an opposite side to a direction of insertion into the insertion hole in the cover-side engagement portion is aligned with an opening end portion of the insertion hole in a state in which the cover-side engagement portion is inserted in the insertion hole.

6. The in-vehicle equipment holding device according to claim 1, wherein
the non-binding combiner is provided by forming the tether integrally with the in-vehicle equipment bracket or/and the cover.

7. The in-vehicle equipment holding device according to claim 6, wherein
in a case in which the non-binding combiner is provided by forming the tether integrally with the in-vehicle equipment bracket or the cover, the non-binding combiner has a non-integrated member engagement portion that engages with a non-integrated member that is the in-vehicle equipment bracket or the cover and that is not formed integrally with the tether.

8. The in-vehicle equipment holding device according to claim 7, wherein
the non-integrated member engagement portion has an insertion path that extends to inside of the non-integrated member engagement portion from outside of the non-integrated member engagement portion, and an engagement release structure for releasing engagement between the non-integrated member engagement portion and the non-integrated member is formed in the insertion path.

9. The in-vehicle equipment holding device according to claim 7, wherein
the non-integrated member has an insertion hole into which the non-integrated member engagement portion is inserted, and
a rear end on an opposite side to a direction of insertion into the insertion hole in the non-integrated member engagement portion is aligned with an opening end portion of the insertion hole in a state in which the non-integrated member engagement portion is inserted in the insertion hole.

10. The in-vehicle equipment holding device according to claim 8, wherein
the non-integrated member has an insertion hole into which the non-integrated member engagement portion is inserted, and
a rear end on an opposite side to a direction of insertion into the insertion hole in the non-integrated member engagement portion is aligned with an opening end portion of the insertion hole in a state in which the non-integrated member engagement portion is inserted in the insertion hole.

11. The in-vehicle equipment holding device according to claim 1, wherein
the in-vehicle equipment holding device is disposed at the windshield at a position near an instrument panel of the automobile.

12. The in-vehicle equipment holding device according to claim 6, wherein
the in-vehicle equipment holding device is disposed at the windshield at a position near an instrument panel of the automobile.

13. The in-vehicle equipment holding device according to claim 1, wherein
in the state in which the in-vehicle equipment bracket and the cover are combined,
the bracket-side engagement portion and the cover-side engagement portion are close to each other on a forward side in a direction in which the cover is slid to be attached to the in-vehicle equipment bracket, and
the connection portion is folded back on a backward side that is an opposite side to the forward side.

14. The in-vehicle equipment holding device according to claim 2, wherein
in the state in which the in-vehicle equipment bracket and the cover are combined,
the bracket-side engagement portion and the cover-side engagement portion are close to each other on a forward side in a direction in which the cover is slid to be attached to the in-vehicle equipment bracket, and
the connection portion is folded back on a backward side that is an opposite side to the forward side.
